(19) United States
(12) Patent Application Publication
(10) Pub. No.: US 2026/0269113 A1
(43) Pub. Date: Sep. 10, 2026

(54) HOLDING UNIT FOR SAFETY CONTROL DEVICE FOR ROBOT AND ASSOCIATED HANDHELD ROBOTIC CONTROL DEVICE

(71) Applicant: ABB SCHWEIZ AG, Baden (CH)

(72) Inventors: XiuXiu Yin, Shanghai (CN); Peng Kong, Shanghai (CN); Shaoyu Deng, Shanghai (CN); Jonas Haulin, Shanghai (CN)

(21) Appl. No.: 19/662,518

(22) Filed: Apr. 29, 2026

Related U.S. Application Data
(63) Continuation of application No. PCT/CN2023/130423, filed on Nov. 8, 2023.

(51) Int. Cl. H01F 7/02

(52) U.S. Cl. CPC H01F 7/0252

(57) ABSTRACT

Embodiments of the present disclosure relate to a holding unit for a safety control device for a robot, including a holding part configured to hold the safety control device; and a support part coupled with the holding part and having a magnetic region; wherein the magnetic region is disposed at one side of the holding part and configured such that a user device can be magnetically attached to the magnetic region and positioned alongside the safety control device when the safety control device is held by the holding part.

### FIELD OF THE INVENTION

This invention relates to the robot technique, and more particularly to a holding unit for a safety control device for a robot and an associated handheld robotic control device.

### BACKGROUND OF THE INVENTION

A teach pendant unit (TPU) is generally provided to tune or teach the robot before the codes are run by a controller to enable the robot to enter a normal operation mode, e.g., processing a work piece.

Also, a safety control device including an emergency stop button and one or more enable button is generally required for a robot during the operation or control of the robot, to ensure the safety of the robot and the user.

### SUMMARY OF THE INVENTION

The invention is defined by the claims.

According to one aspect of the disclosure, there is provided a holding unit for a safety control device for a robot, comprising: a holding part configured to hold the safety control device; and a support part coupled with the holding part and having a magnetic region; wherein the magnetic region is disposed at one side of the holding part and configured such that a user device can be magnetically attached to the magnetic region and positioned alongside the safety control device when the safety control device is held by the holding part.

With the above holding unit, those skilled in the art will appreciate that the holding unit can be adapted to almost all user devices, regardless of its size. Also, the holding unit may be easily manufactured, used and detached.

In some embodiments, said user device may comprise a user interaction terminal including a tablet PC, a smart phone, or a laptop.

In some embodiments, the holding part may comprise a concave portion for receiving the safety control device.

In some embodiments, the concave portion may comprise two side walls arranged at two opposite sides of the concave portion and extending along a first direction for clamping two long sides of the safety control device.

In some embodiments, the concave portion may comprise two side openings arranged at another two opposite sides of the concave portion and each extending along a second direction perpendicular to the first direction, wherein the concave portion is configured such that the safety control device can slide through any of the two side openings along the first direction.

In some embodiments, the two side walls each may comprise a respective rib extending along the first direction at an upper edge of the two side walls and protruding towards an inner space of the concave portion, so as to confine the safety control device within the concave portion when the safety control device is held by the holding part.

In some embodiments, at least one of the two side walls is resilient.

In some embodiments, a cross-sectional shape of the concave portion conforms to that of the safety control device.

In some embodiments, the holding part may comprise any of an insertion structure, a sliding feature, a clip-on structure and a snap-on structure.

In some embodiments, the support part is a planar plate integrated with and extending from one side wall of the concave portion.

In some embodiments, a magnet is embedded within or attached on the support part to form the magnetic region.

In some embodiments, the holding part has a length shorter than a length of the safety control device along the first direction.

In some embodiments, the holding unit except the magnetic region is made of plastic.

In some embodiments, a backside of the user device is attached with a metal or magnetic sticker.

According to another aspect of the disclosure, there is provided a handheld robotic control device, comprising: the holding unit as described above; and a safety control device held by the holding unit.

In some embodiments, the handheld robotic control device may further comprise a user device attached to the magnetic region of the holding unit.

According to yet another aspect of the disclosure, there is provided a method of using a holding unit for a safety control device for a robot, comprising: mounting a safety control device in the holding part of the holding unit as described above; and magnetically attaching a user device to the magnetic region of the support part of the holding unit.

### BRIEF DESCRIPTION OF THE DRAWINGS

In the drawings, similar/same reference signs throughout different views generally represent similar/same parts. Drawings are not necessarily on scale. Rather, emphasis is placed upon the illustration of the principles of the present invention. In these drawings:

FIGS. 1A, 1B and 1C illustrate different views of a first example of a conventional holding unit for a safety control device for a robot;

FIGS. 2A and 2B illustrate different views of a second example of a conventional holding structure for a safety control device for a robot;

FIGS. 3A and 3B illustrate different views of a third example of a conventional holding unit for a safety control device for a robot;

FIG. 4 illustrates a schematic diagram of the holding unit according to one embodiment of the present disclosure;

FIG. 5 illustrates a schematic diagram of a safety control device mounted on the holding unit according to one embodiment of the present disclosure;

FIG. 6A illustrates a schematic diagram of a first application scenario where a smart phone is attached to a holding unit holding a safety control device according to one embodiment of the present disclosure;

FIG. 6B illustrates a schematic diagram of a second application scenario where a tablet computer is attached to a holding unit holding a safety control device according to one embodiment of the present disclosure; and

FIG. 7 illustrates a flowchart of a method of using the holding unit device according to one embodiment of the present disclosure.

### DETAILED DESCRIPTION OF THE EMBODIMENTS

Embodiments of the present disclosure will be described in more details with reference to the drawings. Although the drawings illustrate some embodiments of the present disclosure, it should be appreciated that the present disclosure can be implemented in various manners and should not be interpreted as being limited to the embodiments explained herein. On the contrary, the embodiments are provided to understand the present disclosure in a more thorough and complete way. It should be appreciated that drawings and embodiments of the present disclosure are only for exemplary purposes rather than restricting the protection scope of the present disclosure.

In the descriptions of the embodiments of the present disclosure, the term “includes” and its variants are to be read as open-ended terms that mean “includes, but is not limited to.” The term “based on” is to be read as “based at least in part on.” The terms “one embodiment” and “this embodiment” are to be read as “at least one embodiment.” The following text also can comprise other explicit and implicit definitions.

As mentioned above, a teach pendant unit (TPU) and a safety control device are generally required for a robot. Typically, there are three different types of combination for the TPU and the safety control device in the market.

A first type of combination is an all-in-one device integrating a TPU and necessary safety control units (including e.g., an emergency stop button and an enable switch) together. Also, a display screen and/or a user interaction interface are integrated therein to allow users to control and view the status of the robot. Such a type of combination is typically known as a traditional TPU. With such a traditional TPU, the display screen and the safety control unit cannot be separated. Also, the traditional TPU must be physically connected to controller to provide functionality. That means, it is difficult to take the TPU away. In addition, the traditional TPU is generally bulky, of high price and expensive to maintain.

A second type of combination is that the TPU and the safety control device are separately provided and they cannot be assembled together. In practice, the TPU is generally realized by a user device including a personal computer (PC), a tablet, or a smart phone etc. In this way, the cost may be reduced. However, the associated problem is that one cannot hold the safety control device and the user device served as the TPU with one hand, which may lead to inconvenience.

A third type of combination is that although the TPU and the safety control device are separately provided, they can be detachably assembled together with a holding structure. However, it is found that the conventional holding structure would be either bulky or unfriendly.

To better understand the problem of the conventional holding structures, the followings are some examples.

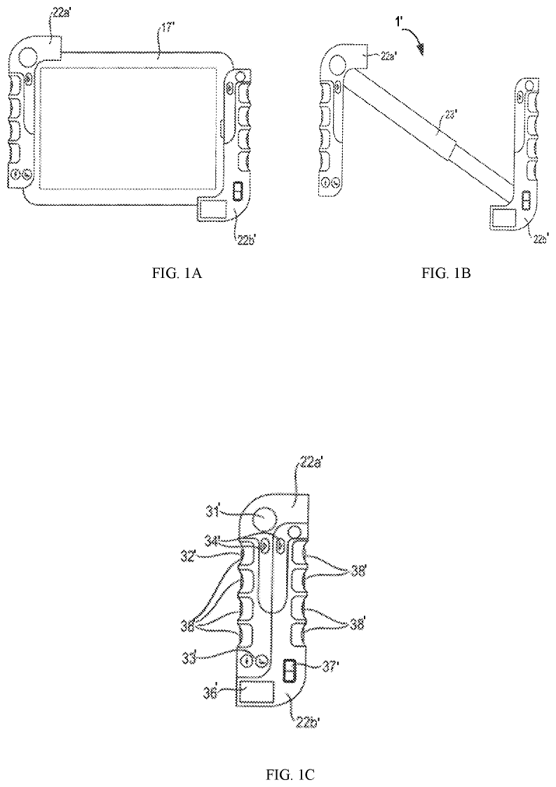

FIGS. 1A, 1B and 1C illustrate different views of a first example of a conventional holding structure.

As illustrated in FIGS. 1A, 1B and 1C, an extendable holding structure 1′ is provided, comprising two holding parts 22a′, 22b′ and a length-adjustable coupling rod 23′ connecting between the two holding parts 22a′, 22b′. Also, the extendable holding structure 1′ itself is integrated with some safe control units including e.g., an emergency stop button 31′ and a plurality of enabling buttons 32′, 33′, 34′, 36′, 37′. When the extendable holding unit 1′ is used to hold the personal device 17, a user needs to pull the two holding parts 22a, 22b in opposite directions, so as to accommodate the user device 17′. The problem with such an extendable holding structure 1′ is that the extendable holding structure 1′ cannot be separated from the safe control device, and cannot be adapted to various sizes of the user device 17′ (including e.g., a laptop or a small phone of small size) serving as the TPU. In addition, it might be difficult to pull the two holding parts 22a, 22b.

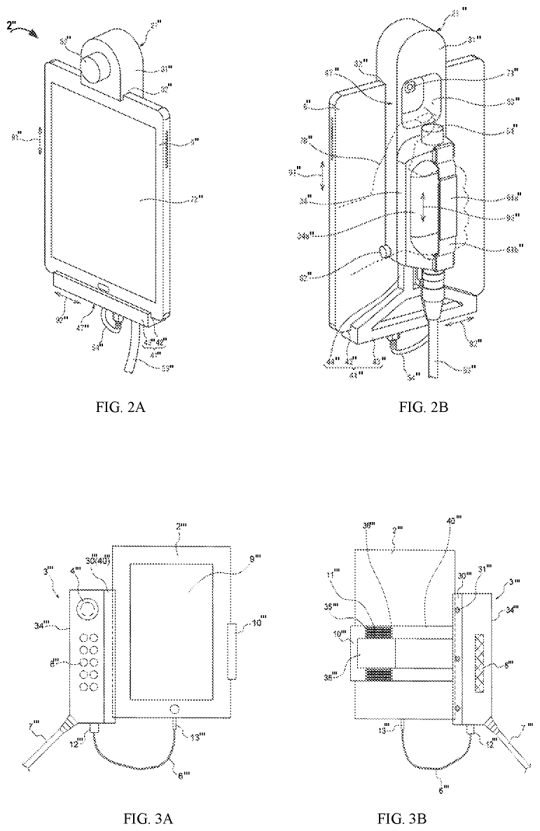

FIGS. 2A and 2B illustrate different views of a second example of a conventional holding structure for a safety control device for a robot.

As illustrated in FIGS. 2A and 2B, a holding structure 2″ comprising a slidable part 44″ is provided. By pulling out the slidable part 44″, the extendable holding structure 2″ may accommodate a user device 6″. Also, the extendable holding structure 2″ itself is integrated with some safe control units including e.g., an emergency stop button 52″ and an enable switch 51″. Just like the first example of the conventional holding structure 1′, the extendable holding structure 2″ also has the problem that it cannot be separated from the safe control device and cannot be adapted to various user device 6″ (including e.g., a laptop) serving as the TPU. In addition, it might be difficult to pull out the slidable part 44″.

FIGS. 3A and 3B illustrate different views of a third example of a conventional holding unit for a safety control device for a robot.

As illustrated in FIGS. 3A and 3B, a holding structure 3″′ is provided, comprising an attachment body 40″′ fixed onto an operation unit body 34″′. The attachment body 40″′ has a spring 11″′ such that the attachment body 40″′ can be extended to accommodate a user device 2″′. The operation unit body 34″′ comprising an emergency stop button 4″′ and a plurality of operation buttons 8″′ may also serve as a safety control device. Just like the first and second examples of the conventional holding structures, the holding structure 3″′ also has the problem that it cannot be separated from the safe control device and cannot be adapted to various user device 2″′ (including e.g., a laptop) serving as the TPU. In addition, it might be difficult to pull out the attachment body 40″′.

The present application aims to provide an improved holding unit that may overcome or alleviate the problem of the conventional holding structures. To this end, an improved holding unit for a safety control device for a robot is provided, comprising: a holding part configured to hold the safety control device; and a support part coupled with the holding part and having a magnetic region, wherein the magnetic region is disposed at one side of the holding part and configured such that a user device can be magnetically attached to the magnetic region and positioned alongside the safety control device when the safety control device is held by the holding part. Those skilled in the art would appreciate that the improved holding unit would be light-weight and more friendly to users. Also, it can be adapted to various size of the user devices that serves as the TPU.

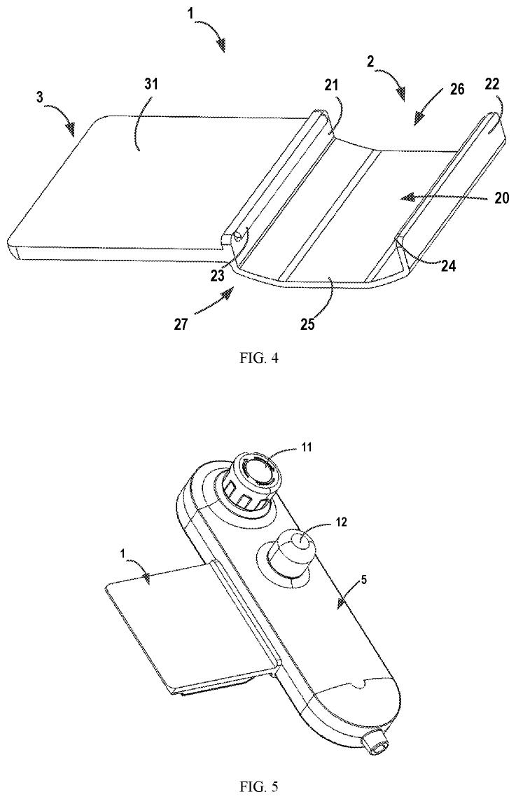

For better understanding of the present disclosure, FIG. 4 illustrates a schematic diagram of the holding unit according to one embodiment of the present disclosure; and FIG. 5 illustrates a schematic diagram of a safety control device mounted on the holding unit according to one embodiment of the present disclosure.

As shown in FIGS. 4 and 5, the holding unit 1 may comprise a holding part 2 and a support part 3.

The holding part 2 is configured for holding a safety control device 5, which is essential for the safety operation of the robot (not shown). Typically, the safety control device 5 may comprise at least an emergency stop button 11 and one or more enable switch 12. It is known in the art that the emergency stop button 11 is a button for transmitting a signal for immediately stopping the robot being driving and the enable switch 12 is a permission switch for transmitting a signal for permitting the robot to operate. Just as an example for operating the robot with the safety control device 5, a user may operate the robot while pressing the enable switch 12 and when the user releases the enable switch 12, the robot may be automatically stopped.

For holding the safety control device 5, in some embodiments the holding part 2 may comprise a concave portion 20 for receiving the safety control device 5. Typically, a cross-sectional shape of the concave portion 20 is designed to conform to that of the safety control device 5. In some embodiments, the concave portion 20 may comprise at least two side walls 21 and 22 opposed to each other and a bottom wall 25 connecting between the two walls. Just as an example, the two side walls 21 and 22 may be arranged at two opposite sides of the concave portion 20 and each extend (e.g., in parallel) along a first direction 41, and configured to clamp or hold two long sides of the safety control device 5.

To facilitate the fixation of the safety control device 5 into the concave portion 20, in some embodiments, the concave portion 20 may further comprise two side openings 26, 27, which may be arranged at another two opposite sides of the concave portion 20 and each extend along a second direction 42 perpendicular to the first direction 41. Particularly, the two side walls 21 or 22 may be spaced apart from each other at their both ends by a corresponding one of the two side openings 26, 27. With the above design of the side openings 26, 27, those skilled in the art would appreciate that in some embodiments, the safety control device 5 can slide through any of the two side openings 26, 27 along the first direction 41 and then be accommodated by the concave portion.

Typically, in some embodiments, the concave portion 20 may have a length equal to or smaller than a length of the safety control device 5 along the first direction 41. In some embodiments, the concave portion 20 may have a width slightly larger than a width of the safety control device 5. In some embodiments, the two side walls 21, 22 each may have a height lower, equal to or slightly higher than thickness of the safety control device 5. With the above designs of the concave portion 20, those skilled in the art would appreciate that the concave portion 20 can be realized in reduced size as compared to the size of the safety control device 5 and would not adversely affect the appearance of the safety control device 5.

In some embodiments, the two side walls 21, 22 each may comprise a respective rib 23, 24 extending along the first direction 41 at an upper edge of the two side walls 21, 22 and protruding towards an inner space of the concave portion 20. In this way, the respective rib 23, 24 may serve to clamp the lateral sides of safety control device 5 securely and/or as a limit stop to confine the safety control device within the concave portion 20 in a direction perpendicular to the first direction 41 and the second directions 42.

In some embodiments, one of the two side walls 21, 22 may be resilient, which may facilitate the insertion and fixation of the safety control device inside the concave portion 20.

Although in the above description, the holding part 2 is designed with a concave portion 20, it should be understood that this is not a limitation and the holding part 2 could be any structure suitable to hold the safety control device 5 including e.g., a sliding feature, a clip-on structure, a snap-on structure or an insertion structure. That is, the holding part 2 without a concave portion 20 is also possible.

Just as some examples, in embodiments with no concave portion 20, the holding part 2 may be simply realized by an insertion structure (e.g., defining a hole or alike for the safety control device to insert therein), a sliding structure (e.g., one or more sliding rails), a clip-on structure and/or a snap-on structure. Then, the safety control device 5 may be inserted or mounted on the holding part via said insertion structure, said sliding structure (e.g., one or more sliding rails), said clip-on structure and/or said snap-on structure.

In some embodiments, the design of the concave portion 20 could also be combined with the design of an insertion structure, a sliding structure (e.g., one or more sliding rails), a clip-on structure and/or a snap-on structure. Even further, those structures described in the above conventional holding units for holding the user device could be adaptively adopted herein to hold the safety control device.

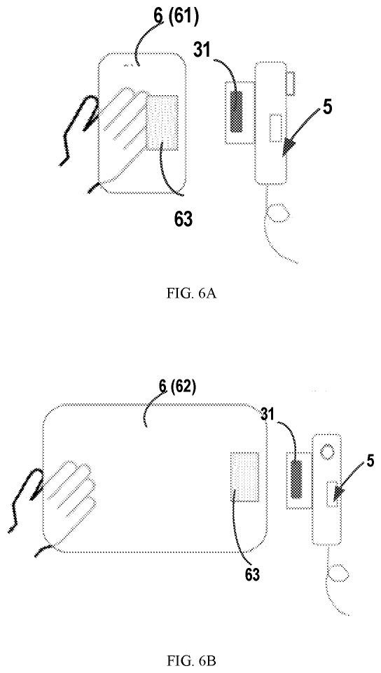

The support part 3 is coupled with the holding part 2 and serve to be magnetically attached by a user device 6 (shown in FIGS. 6A and 6B). In some embodiment, the support part 3 may be integrated with the holding part 2. In some embodiments, the support part 3 may be a separate component that is detachably connected with the holding part 2.

The user device 6 may be any device comprising, but not limit to, a smart phone, or a personal computer including a tablet computer or a laptop.

In order to facilitate the magnetic attachment, in some embodiments, the support part 3 may have a magnetic region 31 disposed at one side of the holding part 2 and configured such that a user device 6 may be magnetically attached to the magnetic region 31 and positioned alongside the safety control device 5 when the safety control device 5 is held by the holding part 2.

Typically, in some embodiments, a magnet may be embedded within the support part 3 or attached onto the surface of the support part 3 to form the magnetic region 31. In some embodiments, a magnetic sticker may be attached onto the surface of the support part 3 to form the magnetic region 31.

In some embodiments, the support part 3 may be a planar plate integrated with the holding part 2 and extending from one side wall 21 of the concave portion 20. In this way, it will be more convenient for the user device 6 to be attached to the support part 3.

To facilitate the manufacturing, the holding unit 1 except the magnetic region 31 may be made of plastic. However, this is not a limitation. In some embodiments, the holding unit except the magnetic region made of other material (e.g., metal) is also possible.

In some embodiments, the support part 3 may have a length equal to the length of the holding part 2. In some embodiments, the support part 3 may have a width that is comparable to the width of the safety control device 5 or the holding part 2. In this way, those skilled in the art would appreciate that the whole holding unit 1 would have a small size as compared to the safety control device 5.

To facilitate the magnetic attachment of the user device 6, a backside of the user device 6 may be attached with a metal or magnetic sticker, the metal may be selected from ferromagnetic material such as Iron, Cobalt, Nickel, etc. or related metallic alloys. However, this is not a limitation. In the case that the user device 6 itself has those ferromagnetic material, there is no need to attach a metal or magnetic sticker on its backside.

The followings are some exemplary application scenarios for using the holding unit, which will be described with reference to FIGS. 6A and 6B.

FIG. 6A illustrates a schematic diagram of a first application scenario where a smart phone is attached to a holding unit holding a safety control device according to one embodiment of the present disclosure.

As shown in FIG. 6A, the user device 6 may be a smart phone 61, which may serve as a TPU. A metal or a magnetic sticker 63 may be attached to the backside of the smart phone 61. It is noted that the metal or a magnetic sticker 63 may be attached to any position of the backside of the smart phone 61, which may help to realize a desired orientation for the smart phone and a desired juxtaposition of the smart phone 61 and the safety control device 5. In this way, the smart phone 61 may then be magnetically attached to the support part 3 of the holding unit 1 via the magnetic region 31 conveniently. In the meantime, the safety control device 5 may be received or held by the holding part of the holding unit 1.

With the above arrangement, those skilled in the art would appreciate that the smart phone 61 and the safety control device 5 may then be juxtaposed via the holding unit 1 and may be held by one hand, which may facilitate the user to operate the smart phone 61 and/or the safety control device 5 with another hand.

In addition, due to the light weight of the holding unit 1 and the safety control device 5, the user may hold any part of the assembly of the smart phone 61 and the safety control device 5.

Once the operation of the robot is finished, the smart phone 61 and/or the safety control device 5 may be easily removed and taken away as desired.

FIG. 6B illustrates a schematic diagram of a second application scenario where a tablet computer is attached to a holding unit holding a safety control device according to one embodiment of the present disclosure.

As shown in FIG. 6B, the user device 6 may be a tablet computer 62, which may serve as a TPU. A metal or a magnetic sticker 63 may be attached to the backside of the tablet computer. It is noted that the metal or a magnetic sticker 63 may be attached to any position of the backside of the tablet computer 62, which may help to realize a desired orientation for the tablet computer 62 and a desired juxtaposition of the tablet computer 62 and the safety control device 5. In this way, the tablet computer 62 may then be magnetically attached to the support part 3 of the holding unit via the magnetic region 31 conveniently. In the meantime, the safety control device 5 may be received or held by the holding part of the holding unit 1.

With the above arrangement, those skilled in the art would appreciate that the tablet computer 62 and the safety control device 5 may then be juxtaposed via the holding unit 1 and may be held by one hand, which may facilitate the user to operate the tablet computer 62 and/or the safety control device 5 with another hand.

In addition, due to the light weight of the holding unit 1 and the safety control device 5, the user may hold any part of the assembly of the tablet computer 62 and the safety control device 5.

Once the operation of the robot is finished, the tablet computer 62 and/or the safety control device 5 may be easily removed and taken away as desired.

Various embodiments have been described with respect to the holding unit. Those skilled in the art would appreciate that there are a plenty of advantages with the holding unit, which may be listed as below.
The holding unit can be adapted to all user devices, whether it is of large size or small size. Also, it has a small size and can be easily used.
The holding unit can be combined with and/or detached from the safety control device. In the case that the holding unit is detached, the holding unit can be stored away.
The holding unit can be attached to anywhere on the user device via the metal or magnetic sticker based on user's need. For example, it can be attached to the left, right, top, bottom or even corner of a tablet computer or a laptop. Also, the attached position can be easily changed by attaching another metal or magnetic sticker onto the surface of the user device.
The cost of the holding unit may be significantly decreased, as the holding unit may be easily manufactured and the metal or magnetic sticker is cheap. Users do not need to buy any special user device (e.g., a mobile terminal) from a robot company, and they can use their own user device easily.
The design of the holding unit does not affect the user experience of the user device (e.g., a mobile terminal) as the metal or magnetic sticker can be very thin. Also, it will also not affect the safety control functions of the safety control device.
It can be easily removed without needs to unlatch the clip-on or unlock the user device as in the case of the conventional holding structures.
The maintenance is easy and of low cost. In the case that the users want to use another user device (e.g., a mobile terminal), it would be easy to fetch another metal or magnet sticker to attach to said another user device. It does not need to take care of the maintenance of the clip-on or similar mechanical design as in the conventional holding structure.

Although the above description is mainly described with respect to the holding unit, it is understood that the present disclosure may also relate to a handheld robotic control device, which may comprise a holding unit as described above and a safety control device that is held by the holding unit. In addition, the handheld robotic control device may further comprise a user device comprising mobile terminals selected from e.g., a personal computer (including a tablet computer) or a smart phone.

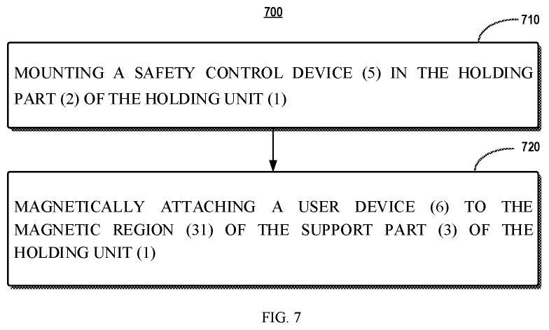

In addition, the present disclosure may also relate to a method of using a holding unit. For better understanding of this method, FIG. 7 illustrates a flowchart of a method of using a holding unit according to one embodiment of the present disclosure.

The method 700 may simply comprise: at block 710, mounting a safety control device in the holding part of the holding unit; and at block 720, magnetically attaching a user device to the magnetic region of the support part of the holding unit.

It is noted that although the above method is described with steps in sequence. The sequence of the steps in the method may be changed, reordered, combined, omitted, modified, etc., as appropriate for different application scenarios.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A holding unit for a safety control device for a robot, comprising:
a holding part configured to hold the safety control device; and
a support part coupled with the holding part and having a magnetic region;
wherein the magnetic region is disposed at one side of the holding part and configured such that a user device can be magnetically attached to the magnetic region and positioned alongside the safety control device when the safety control device is held by the holding part.

2. The holding unit of claim 1, wherein the user device comprises a user interaction terminal including a tablet PC, a smart phone, or a laptop.

3. The holding unit of claim 1, wherein the holding part comprises a concave portion for receiving the safety control device.

4. The holding unit of claim 3, wherein the concave portion comprises two side walls arranged at two opposite sides of the concave portion and extending along a first direction for clamping two long sides of the safety control device.

5. The holding unit of claim 4, wherein the concave portion comprises two side openings arranged at another two opposite sides of the concave portion and each extending along a second direction perpendicular to the first direction,
wherein the concave portion is configured such that the safety control device can slide through any of the two side openings along the first direction.

6. The holding unit of claim 4, wherein the two side walls each comprise a respective rib extending along the first direction at an upper edge of the two side walls and protruding towards an inner space of the concave portion, so as to confine the safety control device within the concave portion when the safety control device is held by the holding part.

7. The holding unit of claim 1, wherein at least one of the two side walls is resilient.

8. The holding unit of claim 1, wherein a cross-sectional shape of the concave portion conforms to that of the safety control device.

9. The holding unit of claim 1, wherein the holding part comprises any of an insertion structure, a sliding feature, a clip-on structure and a snap-on structure.

10. The holding unit of claim 4, wherein the support part is a planar plate integrated with and extending from one side wall of the concave portion.

11. The holding unit of claim 1, wherein a magnet is embedded within or attached on the support part to form the magnetic region.

12. The holding unit of claim 4, wherein the holding part has a length shorter than a length of the safety control device along the first direction.

13. The holding unit of claim 1, wherein the holding unit except the magnetic region is made of plastic.

14. The holding unit of claim 1, wherein a backside of the user device is attached with a metal or magnetic sticker.

15. A handheld robotic control device, comprising:
the holding unit of claim 1; and
a safety control device held by the holding unit.

16. The handheld robotic control device of claim 15, further comprising:
a user device attached to the magnetic region of the holding unit.

17. A method of using a holding unit for a safety control device for a robot, comprising:
mounting a safety control device in the holding part of the holding unit according to claim 1; and
magnetically attaching a user device to the magnetic region of the support part of the holding unit.
